(19) United States
(12) Patent Application Publication
(10) Pub. No.: US 2008/0271073 A1
(43) Pub. Date: Oct. 30, 2008

(54) METHOD OF PROVIDING KEY CODE INFORMATION AND VIDEO DEVICE THEREOF

(75) Inventors: Dong-young KIM, Seongnam-si (KR); Jin-woo Hong, Suwon-si (KR); Dae-gyu Bae, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/868,985

(22) Filed: Oct. 9, 2007

Related U.S. Application Data
(60) Provisional application No. 60/913,620, filed on Apr. 24, 2007.

(30) Foreign Application Priority Data
Jul. 4, 2007 (KR) 10-2007-0067159

(51) Int. Cl. H04N 5/445; G06F 3/00; H04N 5/44

(52) U.S. Cl. 725/37; 348/734; 715/716; 348/E05.002; 348/E05.103

(57) ABSTRACT

A method of providing key code information of an external device and a video device thereof are provided. The method of providing key code information includes transmitting a message for requesting supportable key code information of a connected external device, and receiving a response message regarding the supportable key code information from the external device in response to the request message. Accordingly, the video device can provide the key code information supported by the external device to a user.

### CROSS-REFERENCE TO RELATED APPLICATIONS

This application claims priority from U.S. Provisional Application No. 60/913,620, filed Apr. 24, 2007 in the United States Patent and Trademark Office, and Korean Patent Application No. 10-2007-67159, filed Jul. 04, 2007 in the Korean Intellectual Property Office, the disclosures of which are incorporated herein by reference in their entirety.

### BACKGROUND OF THE INVENTION

1. Field of the Invention

Apparatuses and methods consistent with the present invention relate to providing key code information, and more particularly to providing key code information of a connected external device.

2. Description of the Related Art

FIG. 1 is a block diagram illustrating a related art video system constructed according to the High Definition Multimedia Interface Consumer Electronics Control (HDMI CEC) standard. The video system as illustrated in FIG. 1 comprises a television (TV) 10 and a digital versatile disc recorder (DVDR) 20 connected to each other according to the HDMI CEC standard. A control signal, in addition to a video signal, is transferred between the TV 10 and the DVDR 20 according to the HDMI CEC standard.

Accordingly, the TV 10 can transfer a user command that is transferred through a remote controller 15 to the DVDR 20. That is, a user can control operations of the DVDR 20 by using the remote controller 15 of the TV 10 only.

However, in order for the user to control the DVDR 20 by using the remote controller 15 of the TV 10, the user needs to know what functions of the remote controller 15 are supported by the DVDR 20. Also, when another external device, in addition to the DVDR 20, is connected according to the HDMI CEC standard, the user needs to know what functions of the remote controller 15 are supported by the other external device.

As described above, in order to control an external device by using the remote controller 15 of the TV 10, it is required for a user to know keys of the remote controller 15 supported by the external device, and this causes the user inconvenience. If the user does not know keys supported by the external device, the user should confirm which keys are supported by the external device by pressing the keys of the remote controller 15 one by one.

In addition, since external devices are diversified, a user cannot actually know functions of all the external devices. In this respect, there is a need for a scheme to enable the user to control the external devices through the remote controller of the TV more conveniently.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the exemplary embodiments of the present invention is to provide a method of acquiring supportable key code information of a connected external device and a video device thereof, as a scheme to enable a user to control the external device through a TV remote controller more conveniently.

Another aspect of the exemplary embodiments of the present invention is to provide a method of providing supportable key code information to an external device, and a video device thereof.

According to an aspect of the present invention, there is provided a method of providing key code information which comprises transmitting a message for requesting supportable key code information of a connected external device; and receiving a response message regarding the supportable key code information from the external device in response to the request message.

The external device may be connected according to the HDMI CEC standard.

The supportable key code information may include key codes defined in the HDMI CEC standard.

The request message may include a command code for requesting the supportable key code information.

The response message may include a command code that indicates a response to the request message and a supportable key code table of the external device.

Bits of the key code table may indicate whether functions, which successively correspond to the key codes defined in the HDMI CEC standard, are supported.

The method of providing key code information invention may further comprise creating a supportable key code user interface (UI) that indicates functions corresponding to the supportable key codes of the external device on the basis of the supportable key code information of the response message; and displaying the supportable key code UI on a display screen.

The method of providing key code information may further comprise receiving the key code input by a user through a key input device; and transmitting the key code input through the key input device to the external device if the input key code corresponds to the supportable key code, while displaying that the input key code corresponds to an unsupportable function if the input key code does not correspond to the supportable key code.

The method of providing key code information may further comprise receiving a message indicating that the external device is in a menu active state from the external device; receiving the key code input by the user through the key input device; and transmitting the key code input through the key input device to the external device if the input key code corresponds to both the supportable key code and the supportable key code in the menu active state defined in the HDMI CEC standard, while displaying that the input key code corresponds to an unsupportable function if the input key code corresponds to either or neither of the supportable key code and the supportable key code in the menu active state defined in the HDMI CEC standard.

The transmitting may be performed when the external device is turned on or when the key code supported by the external device is changed.

According to another aspect of embodiments of the present invention, there is provided a video device, which comprises a control unit which creates a message for requesting supportable key code information of a connected external device; and an interface which transmits the request message to the external device.

The external device may be connected to the video device according to the HDMI CEC standard.

The supportable key code information may include key codes defined in the HDMI CEC standard.

The request message may include a command code for requesting the supportable key code information.

The interface may receive a response message regarding the supportable key code information from the external device in response to the request message.

The response message may include a command code that indicates a response to the request message and a supportable key code table of the external device.

Bits of the key code table may indicate whether functions, which successively correspond to the key codes defined in the HDMI CEC standard, are supported.

The control unit may be constructed to display on a display unit a supportable key code UI that indicates functions corresponding to the supportable key codes of the external device on the basis of the supportable key code information of the response message.

The video device may further comprise a key input device which receives the key codes from a user; wherein the control unit may control the interface to transmit the key code input through the key input device to the external device if the input key code corresponds to the supportable key code, while it may control the display unit to display that the input key code corresponds to an unsupportable function if the input key code does not correspond to the supportable key code.

The video device may further comprise a key input device which receives the key codes from a user; wherein the interface may receive a message indicating that the external device is in a menu active state from the external device; and the control unit may control the interface to transmit the key code input through the key input device to the external device if the input key code corresponds to both the supportable key code and the supportable key code in the menu active state defined in the HDMI CEC standard, while it may control the display unit to display that the input key code corresponds to an unsupportable function if the input key code corresponds to either or neither of the supportable key code and the supportable key code in the menu active state defined in the HDMI CEC standard.

The control unit may create the request message when the external device is turned on or when the key code supported by the external device is changed.

According to yet another aspect of the present invention, there is provided a method of providing key code information, which comprises receiving a message for requesting supportable key code information from a connected external device; and transmitting a response message regarding the supportable key code information to the external device in response to the request message.

The external device may be connected according to the HDMI CEC standard.

According to yet another aspect of the present invention, there is provided a video device, which comprises an interface which receives a message for requesting supportable key code information from a connected external device; and a control unit which creates a response message regarding the supportable key code information in response to the request message, and controls the interface to transmit the response message to the external device.

The external device may be connected to the video device according to the HDMI CEC standard.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a related art block diagram illustrating a video system constructed according to the HDMI CEC standard;

FIG. 2 is a block diagram illustrating an example of a video system to which the present invention can be applied;

FIG. 3 is a flowchart illustrating a method of providing key code information according to an exemplary embodiment of the present invention;

FIG. 4 is a flowchart illustrating a method of providing key code information according to another exemplary embodiment of the present invention;

FIG. 5 is a view illustrating the structure of a message that corresponds to the HDMI CEC standard according to an exemplary embodiment of the present invention;

FIG. 6 is a view illustrating the structure of a request message according to an exemplary embodiment of the present invention;

FIG. 7 is a view illustrating the structure of a response message according to an exemplary embodiment of the present invention;

FIG. 8 is a view illustrating the structure of a supportable key code table according to an exemplary embodiment of the present invention;

FIG. 9 is a table illustrating an example of a key code defined in the HDMI CEC standard according to an exemplary embodiment of the present invention;

FIGS. 10A and 10B illustrate key code UIs according to an exemplary embodiment of the present invention;

FIG. 11 is a block diagram illustrating a construction of a video device according to another exemplary embodiment of the present invention;

FIG. 12 is a flowchart illustrating a method of providing key code information according to another exemplary embodiment of the present invention;

FIG. 13 is a block diagram illustrating the construction of a video device according to still another exemplary embodiment of the present invention; and

FIG. 14 is a flowchart illustrating a method of providing key code information according to still another exemplary embodiment of the present invention.

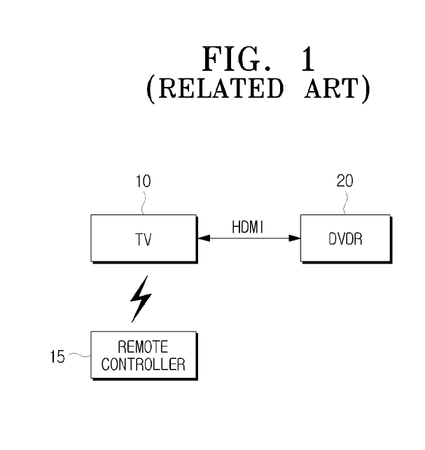

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings.

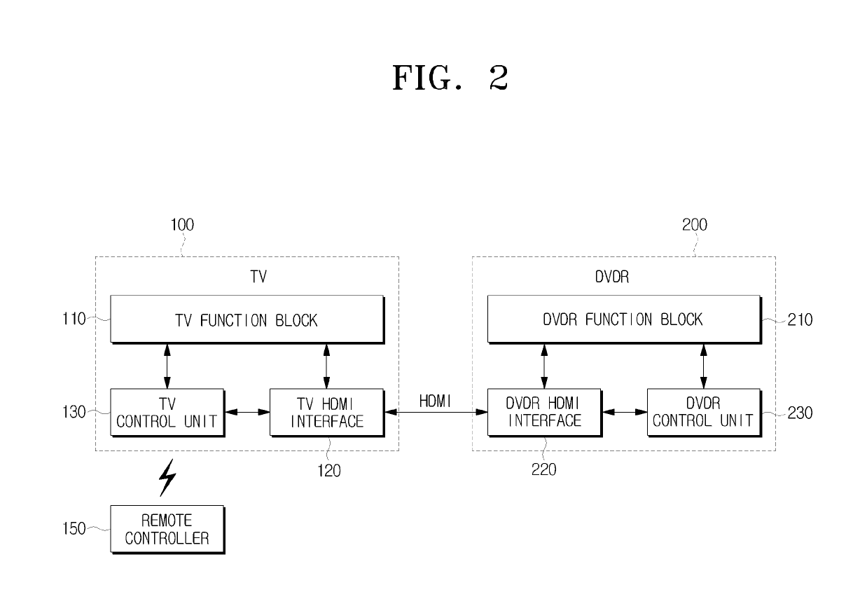

FIG. 2 is a block diagram illustrating an example of a video system to which the present invention can be applied.

As illustrated in FIG. 2, the video system comprises a TV 100 and a DVDR 200 which are connected to each other according to the HDMI CEC standard.

The TV 100 comprises a TV function block 110, a TV HDMI interface 120, and a TV control unit 130, and receives a user command through a remote controller 150, and so on.

The TV function block 110 performs a TV function. Specifically, the TV function block 110 performs signal processing such as decoding, scaling, and so forth, with respect to a broadcasting signal that is received wiredly or wirelessly from a broadcasting station, and displays the processed broadcasting signal on a display screen. Also, the TV function block 110 may display on the display screen an image that corresponds to a video signal transferred from the DVDR 200 through the TV HDMI interface 120 to be described later.

In addition, the TV function block 110 receives UI information of a key code, which can be supported by the DVDR 200, from the TV control unit 130 to be described later, and displays the UI of the supportable key code on the display screen.

The TV HDMI interface 120 is connected to the DVDR 200 according to the HDMI CEC standard, and enables the TV 100 and the DVDR 200 to transmit/receive a video signal and messages having mutual control functions to/from each other.

In addition, the TV HDMI interface 120 transmits a message for requesting from the DVDR 200 supportable key code information that can be supported by the DVDR 200. Also, the TV HDMI interface 120 receives a response message regarding the supportable key code information from the DVDR 200.

The TV control unit 130 controls an operation of the TV function block 110 according to a user command transferred through the remote controller 150. Also, the TV control unit 130 can control an operation of the DVDR 200 by transmitting a control command to the DVDR 200 through the TV HDMI interface 120.

In addition, the TV control unit 130 creates a message for requesting supportable key code information of a connected external device, and transmits the request message to the external device. Also, in response to the request message, the TV control unit 130 receives a response message regarding the supportable key code information from the external device connected to the TV 100 through the TV HDMI interface 120. Here, the external device may be the DVDR 200, a receiver (not illustrated), and so forth.

Then, the TV control unit 130 creates a supportable key code UI that indicates functions corresponding to the supportable key codes of the external device on the basis of the supportable key code information of the response message received from the external device. The TV control unit 130 controls the TV function block 110 to display the created supportable key code UI on a display screen.

In addition, the TV control unit 130 controls the TV HDMI interface 120 to transmit a key code input by a user through the remote controller 150 to the external device if the input key code is a supportable key code. By contrast, the TV control unit 130 controls the TV function block 110 to display on the display screen that the input key code corresponds to an unsupportable function if the input key code is not a supportable key code.

In particular, the HDMI CEC standard prescribes that the TV 100 should transmit a specified key code related to a menu control to the external device connected through the HDMI CEC standard when the external device is in a menu active state. For example, such a menu active state corresponds to inputs of a selection key, direction keys, numeral keys, and function keys F1, F2, F3, F4, and F5.

However, even a specified key related to the menu control may be a key code that is not supported by the external device. Accordingly, the TV control unit 130 according to an exemplary embodiment of the present invention operates not to transmit a key code input through the remote controller 150 to the external device if the input key code, although it corresponds to a specified key code related to the menu control prescribed in the HDMI CEC standard, is not a supportable key code of the external device.

More specifically, the TV control unit 130 receives from the external device a message indicating that the external device is in the menu active state from the external device. The TV control unit 130 also receives a key code input by a user through the remote controller 150. At this time, if the input key code corresponds to both a supportable key code and a supportable key code in the menu active state defined in the HDMI CEC standard, the TV control unit 130 controls the TV HDMI interface 120 to transmit the input key code to the external device. By contrast, if an input key code corresponds to either or neither of a supportable key code and a supportable key code in the menu active state defined in the HDMI CEC standard, the TV control unit 130 controls the TV function block 110 to display on the display screen that the input key code corresponds to an unsupportable function.

For example, the DVDR 200 supports up/down/left/right keys and a selection key, but does not support function keys F1 to F5. By contrast, according to the HDMI CEC standard, when the up/down/left/right key, the selection key, or one of the function keys is input to the TV 100 through the remote controller 150, the TV 100 should transmit the input key to the DVDR 200. However, in the exemplary embodiment of the present invention, the DVDR 200 does not support the function keys, and when one of the function key is input through the remote controller 150, the TV 100 displays on the display screen that the input key corresponds to an unsupportable function.

In addition, when the external device is turned on or a key code supported by the external device is changed, the TV control unit 130 creates a request message for requesting supportable key code information of the external device.

For example, it is assumed that the DVDR 200 supports a play key, a record key, and a stop key. When, the DVDR 200 is connected to the TV 100 according to the HDMI CEC standard, and the power is first turned on, the TV 100 transmits a message for requesting information on a supportable key code to the DVDR 200. In this case, the DVDR 200 transmits a response message indicating that the DVDR supports the play key, the record key, and the stop key to the TV 100.

Then, if the DVDR 200 is in a record state, the record key is not required while the record function is performed. Accordingly, when the DVDR 200 performs the record function, the supportable key code is changed. At this time, The TV 100 transmits a message for requesting information on a supportable key code to the DVDR 200. Then, the DVDR 200 transmits a response message that the DVDR 200 supports the play key and the stop key to the TV 100. As described above, the supportable key code can be changed according to the state of the DVDR 200. Also, whenever the supportable key code is changed, the TV 100 transmits a message for requesting information on a supportable key code to the DVDR 200.

The remote controller 150 receives a key code for controlling the TV 100 from the user and transmits the received key code to the TV 100. Also, the remote controller 150 receives a key code for controlling an external device connected through the HDMI CEC standard.

As illustrated in FIG. 2, the DVDR 200 comprises a DVDR function block 210, a DVDR HDMI interface 220, and a DVDR control unit 230.

The DVDR function block 210 performs a DVDR function. Specifically, the DVDR function block 210 records a broadcasting signal input from the TV 100 through the DVDR HDMI interface 220, to be described later, in a DVD mounted on the DVDR 200, or reads a video signal recorded in the DVD to provide the read video signal to the TV 100 through the DVDR HDMI interface 220.

The DVDR HDMI interface 220 is connected to the TV 100 according to the HDMI CEC standard, and enables the TV 100 and the DVDR 200 to transmit/receive a video signal and messages to/from each other.

The DVDR control unit 230 controls an operation of the DVDR function block 210 according to a control command of the TV control unit 130 that is transferred through the DVDR HDMI interface 220.

In addition, in order to transmit key code information that can be supported by the DVDR 200 to the TV 100, the DVDR control unit 230 creates a response message that comprises the supportable key code information, and transfers the created response message to the TV 100 through the DVDR HDMI interface 220.

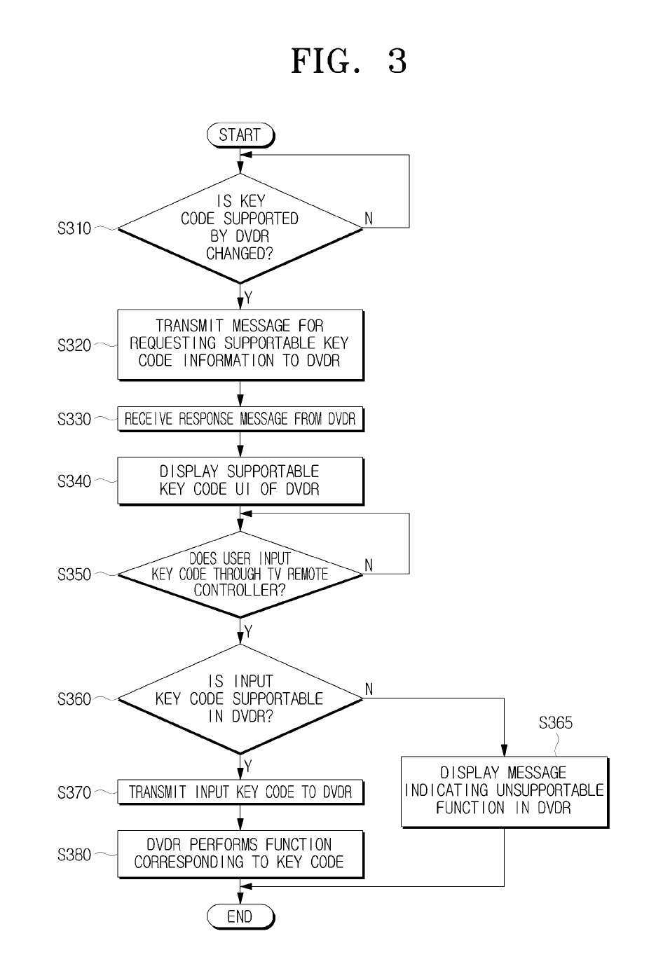

Hereinafter, a series of processes in which the TV 100 acquires the supportable key code information from the external device, and controls the key code value input from the remote controller 150 on the basis of the acquired supportable key code information will be described in detail with reference to FIG. 3.

FIG. 3 is a flowchart illustrating a method of providing key code information according to an exemplary embodiment of the present invention.

As illustrated in FIG. 3, the TV 100 judges whether a key code supported by the DVDR 200 is changed (S310). If the key code supported by the DVDR 200 is changed (S310-Y), the TV 100 transmits a message for requesting supportable key code information to the DVDR 200 (S320). Here, the supportable key code information comprises key codes defined in the HDMI CEC standard. For example, the key codes defined in the HDMI CEC standard comprise Select(0x00), Up(0x01), Down(0x02), . . . , F5(0x76), and Data—see Note 3(0x76). Here, values in parentheses are key code values. For example, “Select” corresponds to the function of a key, and “0x00” means the code value of a “Select” key.

Thereafter, in response to the request message, the TV 100 receives a response message regarding the supportable key code information from the DVDR 200 (S330). The response message comprises a command code indicating that the response message is a response to the request message, and a supportable key code table of the DVDR 200. Respective bits of the key code table indicate whether functions, which successively correspond to the key codes defined in the HDMI CEC standard, are supported.

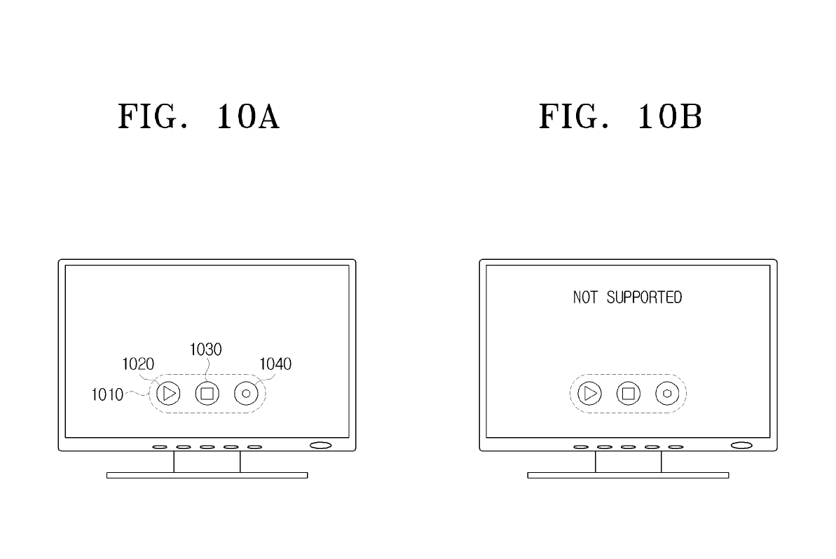

The TV 100 creates and displays a UI for the supportable key codes of the DVDR 200 on the basis of the response message regarding the supportable key code information (S340). For example, if the supportable key codes of the DVDR 200 correspond to a play key, a stop key, and a record key, the TV 100 creates and displays a UI composed of a play icon, a stop icon, and a record icon. An example of such a supportable key code UI can be confirmed with reference to FIG. 10A.

Then, the TV 100 judges whether a key is input by the user through the remote controller 150 (S350). If a key is input by the user through the remote controller 150 (S350-Y), the TV 100 judges whether the input key code is a key code that can be supported by the DVDR 200 (S360). Here, the TV 100 judges whether the key code input through the remote controller 150 is a supportable key code recorded in the response message. More specifically, the response message regarding the supportable key code of the DVDR 200 comprises a supportable key code table, and respective bits of the supportable key code table indicate whether functions, which successively correspond to the key codes defined in the HDMI CEC standard, are supported. For example, in the HDMI CEC standard, the play key has a key code of “0x44”. Accordingly, if the bit that corresponds to the key code of “0x44” in the supportable key code table is “0”, the DVDR 200 does not support the play key. By contrast, if the bit that corresponds to the key code of “0x44” in the supportable key code table is “1”, the DVDR 200 supports the play key. As described above, the TV 100 judges whether a key code is supported by the DVDR 200 by confirming the bits of the supportable key code table of the response message.

If the key code input through the remote controller 150 is a key code that can be supported by the DVDR 200 (S360-Y), the TV 100 transmits the key code input through the remote controller 150 to the DVDR 200 (S370). Then, the DVDR 200 performs a function that corresponds to the received key code (S380). For example, if a play key is input through the remote controller 150, the TV 100 transmits the input play key to the DVDR 200 since the play key corresponds to a key code supported by the DVDR 200. Then, the DVDR 200 performs a play function that corresponds to the play key code.

By contrast, if the key code input through the remote controller 150 is not a key code that can be supported by the DVDR 200 (S360-N), the TV 100 displays a message indicating that the input key code corresponds to a function that is not supported by the DVDR 200 (S390). For example, if a delete key is input through the remote controller 150, the TV 100 displays a message indicating that the input delete key code is not supported by the DVDR 200 (e.g., “Not Supported”).

The method of providing supportable key code information, centering around the TV 100, has been described with reference to FIG. 3.

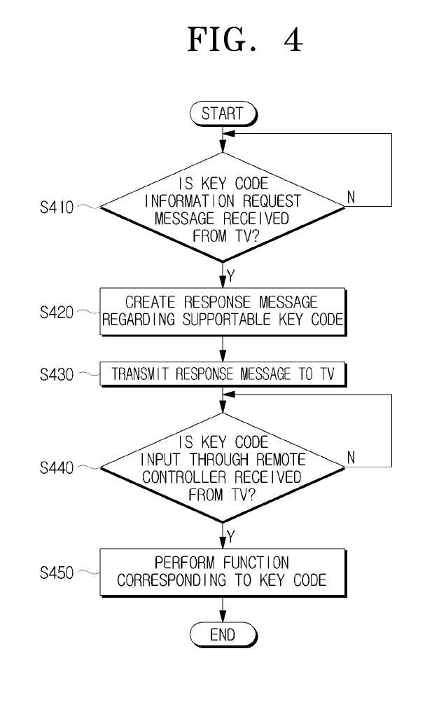

Hereinafter, a method of providing supportable key code information, centering around the DVDR 200, will be described with reference to FIG. 4, which is a flowchart illustrating a method of providing key code information according to another exemplary embodiment of the present invention.

As illustrated in FIG. 4, the DVDR 200 judges whether a message for requesting supportable key code information is received from the TV 100 (S410). If the request message is received (S410-Y), the DVDR 200 creates a response message regarding a supportable key code (S420). Then, the DVDR 200 transmits the created response message to the TV 100 (S430).

Then, the DVDR 200 judges whether a key code input through the remote controller 150 is received from the TV 100 (S440). If the key code is received (S440-Y), the DVDR 200 performs a function corresponding to the key code input through the remote controller 150 (S450).

The method of providing supportable key code information has been described with reference to FIGS. 3 and 4.

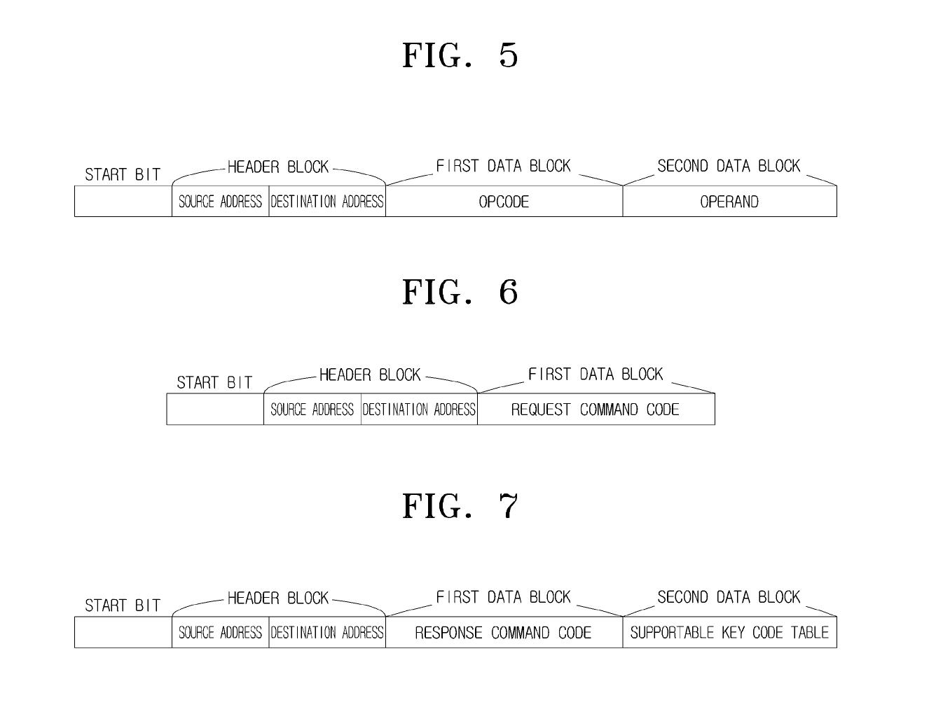

Hereinafter, the structure of a message that is mutually exchanged between the TV 100 and the DVDR 200 will be described in detail with reference to FIGS. 5 to 9.

FIG. 5 is a view illustrating a structure of a message that corresponds to the HDMI CEC standard according to an exemplary embodiment of the present invention.

As illustrated in FIG. 5, a message according to the HDMI CEC standard includes a start bit, a header block, a first data block, and a second data block.

The start bit is a bit that indicates the start part of the message. Generally, it is preferable, but not necessary, that the start bit is composed of one bit. However, the start bit may be composed of a plurality of bits.

The header block comprises a source address and a destination address. The source address is an address of a device that transmits the message, and the destination address is an address of a device that will receive the message. Generally, the source address and the destination address are in the form of a logical address.

In addition, the header block further comprises an End Of Message (EOM) bit (not illustrated) and an Acknowledgement (ACK) bit (not illustrated). The EOM bit is a bit that indicates the end of a message. For example, if the EOM bit is “0”, it means that the message does not arrive at the end of a message, while if the EOM bit is “1”, it means that the message arrives at the end of a message. Since the end of a message can be known through the EOM bit, it becomes possible to create a message having a variable length.

The ACK bit is a bit that indicates whether the message has been transferred to the device of the destination address. For example, when a message is first created, the ACK bit is set to “1”. When the message is transferred to a device that does correspond to a destination address, the device responds to the message with the ACK bit set to “1”. By contrast, when the message is transferred to a device that corresponds to a destination address, the device responds to the message by correcting the ACK bit to “0”. The source device confirms whether the message has been transferred by confirming whether the ACK bit of a response message is “0” or “1”.

Generally, in the HDMI CEC standard, a source address and a destination address has a size of four bits, respectively, and an EOM bit or an ACK bit has a size of one bit. Accordingly, the header block has a size of 10 bits in total.

The first data block comprises an OPCODE. The OPCODE means a code value of a command that corresponds to the role of the message. That is, the code value of the command code is recorded in the OPCODE. For example, a command <Active Source> that is a command to transfer an address of a source that is currently in an active state has an OPCODE value of “0x82”.

The OPCODE is a code value having a size of 8 bits. Also, the first data block has an EOM bit and an ACK bit. Accordingly, the first data block has a size of 10 bits in total.

The second data block comprises an OPERAND. In the OPERAND, a parameter value of a command that corresponds to the OPCODE is recorded. Accordingly, the value of the OPERAND is determined according to the OPCODE. For example, the command <Active Source> is followed by a parameter value called [Physical Address]. Accordingly, the OPERAND comprises [Physical Address] information.

The OPERAND is composed of a plurality of data blocks. Each data block comprises data having a size of 8 bits, an EOM bit, and an ACK bit, and thus has a size of 10 bits. In the HDMI CEC standard, OPERAND has 14 data blocks at maximum. That is, the second data block is composed of 14 data blocks at maximum, and has a maximum size of 140 bits.

As described above, the message is composed of the header block, the first data block, and the second data block, and has a maximum size of 160 bits.

FIG. 6 is a view illustrating a structure of a request message according to an exemplary embodiment of the present invention.

As illustrated in FIG. 6, the request message is composed of a start bit, a header block, and a first data block.

The header block comprises a source address and a destination address. In the exemplary embodiment of the present invention, since the TV 100 transmits a request message to the DVDR 200, a logical address value of the TV 100 is recorded as the source address, and a logical address value of the DVDR 200 is recorded as the destination address.

The first data block comprises a request command code, and is recorded as OPCODE. For example, the request command code may be defined by giving the title <Get Supported Key Code> thereto. Also, the request command code has no parameter value.

However, the request command code may be implemented to have the destination address as a parameter. In this case, the request command code may be expressed as <Get Supported Key Code>([Device Address]), and [Device Address] becomes the OPERAND value of the second data block.

FIG. 7 is a view illustrating a structure of a response message according to an exemplary embodiment of the present invention.

As illustrated in FIG. 7, the response message is composed of a start bit, a header block, a first data block, and a second data block.

The header block comprises a source address and a destination address. In the exemplary embodiment of the present invention, since the DVDR 200 transmits a response message to the TV 100, the logical address value of the DVDR 200 is recorded as the source address, and the logical address value of the TV 100 is recorded as the destination address.

The first data block comprises a response command code, and is recorded as OPCODE. For example, the response command code may be defined by giving the title <Report Supported Key Code> thereto.

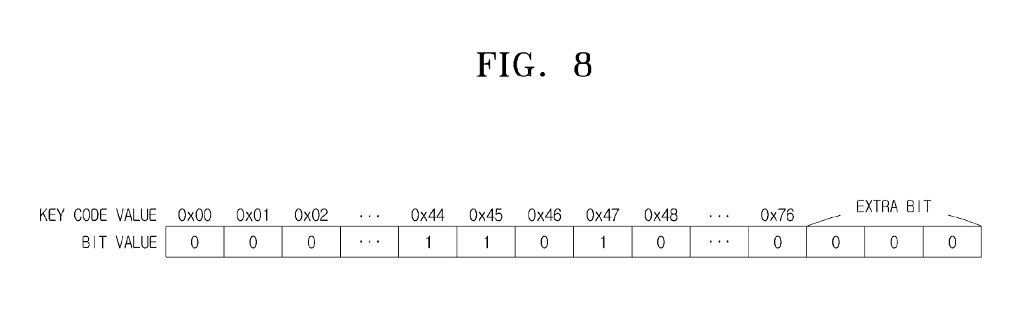

The second data block comprises a supportable key code table. For example, <Report Supported Key Code> may be implemented to have [Supported Key Code Table] as a parameter. A structure of the supportable key code table will be described in detail with reference to FIG. 8.

In addition, the source address may be implemented to have a parameter. In this case, the response command code may be expressed as <Report Supported Key Code>([Source Address]), and [Source Address] and [Supported Key Code Table] are recorded as the OPERAND value.

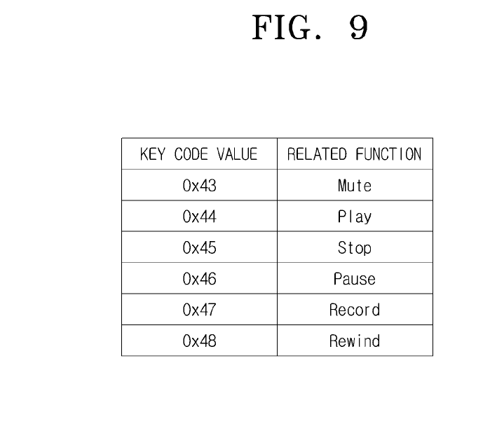

FIG. 8 is a view illustrating a structure of a supportable key code table according to an exemplary embodiment of the present invention, and FIG. 9 is a table illustrating an example of a key code defined in the HDMI CEC standard according to an exemplary embodiment of the present invention.

As illustrated in FIG. 8, the key code table comprises bit values that successively correspond to respective key code values.

The key code values are defined according to the HDMI CEC standard. For example, a key code value “0x43” indicates a mute function. Also, key code values “0x44”, “0x45”, “0x46”, “0x47”, and “0x48” indicate functions of play, stop, pause, record, and rewind, respectively.

In the HDMI CEC standard, functions that correspond to respective key code values are defined as described above. Accordingly, by making the bit values correspond to the respective key code values in the order defined in the HDMI CEC standard, it can be recorded whether the functions that correspond to the key codes are supported. For example, since the bit values of “0x44”, “0x45”, and “0x47” are “1” as shown in FIG. 8, it can be confirmed that the DVDR 200 supports the play, stop, and record keys as shown in FIG. 9.

As described above, whether a specified key is supported can be recorded in the supportable key code table by making the bit values correspond to the respective key code values.

The message structures have been described referring to FIGS. 5 to 9.

In the exemplary embodiments of the present invention, the message is structured on the basis of the structures defined in the HDMI CEC standard. However, this is merely exemplary, and the message structures may also be implemented on the basis of structures defined in other standards. In addition, the message may be structured on the basis of structures optionally defined by manufacturers.

Consequently, the message structure and the message size may be set differently from the exemplary embodiments of the present invention.

Hereinafter, a supportable key code UI will be described with reference to FIGS. 2, 10A and 10B, according to an exemplary embodiment of the present invention.

As illustrated in FIG. 10A, the supportable key code UI includes a boundary 1010, a play icon 1020, a stop icon 1030, and a record icon 1040.

When the TV 100 receives a response message that comprises a supportable key code table as illustrated in FIG. 8, the DVDR 200 supports a play key, a stop key, and a record key. Accordingly, the TV 100 displays the UI that comprises the play icon, the stop icon, and the record icon as shown in FIG. 10.

In addition to the icon type UI as illustrated in FIG. 10A, the supportable key code UI can be created in other methods. For example, the supportable key code UI may be implemented in the form of a menu. In this case, a user can select the menu by using direction keys in the remote controller 150.

The user may directly select an icon being displayed on the display screen of the TV 100, or select the icon by using the play key, the stop key, or the record key of the remote controller 150.

If the user presses an unsupportable key in the remote controller 150, the supportable key code UI may be implemented to display “NOT SUPPORTED” as shown in FIG. 10B. For example, when the user presses a pause key in the remote controller 150, the TV 100 displays “NOT SUPPORTED” on the display screen.

The message for indicating that the selected key is an unsupportable key may be provided in different types in addition to the text type such as “NOT SUPPORTED”. For example, a picture in the form of an icon indicating that the selected key is an unsupported key may be displayed. In addition, a warning sound may be produced as a message indicating that the selected key is an unsupportable key.

Thus far, the methods of providing supportable key code information and the video device thereof have been described in detail.

In the exemplary embodiment of the present invention, it is exemplified that the video system is constructed with the TV 100 and the DVDR 200. However, it is apparent that the technique according to the present invention can also be applied to a video system constructed with other video devices different from the TV 100 and the DVDR 200. Examples of such video devices comprise a Set Top Box, a DVD Player, a Digital Video Recorder, a Personal Video Recorder, a Hard Disc Drive player, a Blu-ray Disc player, a Blu-ray Disc recorder, a Video Cassette Recorder, a home theatre system, a Personal Multimedia Player, a digital camera, a digital camcorder, and so forth.

Also, in the exemplary embodiment of the present invention, it is assumed that the video devices that constitute the video system are connected according to the HDMI CEC standard. However, this is merely exemplary for convenience' sake of explanation. The present invention can be applied to any method in which video devices can transmit/receive video signals and messages to/from each other.

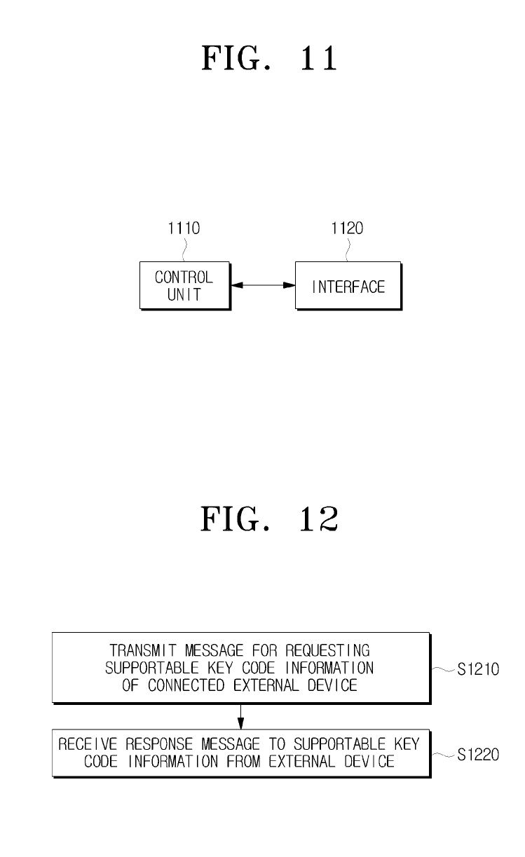

Hereinafter, other exemplary embodiments of the present invention will be described in detail with reference to FIGS. 11 to 14.

FIG. 11 is a block diagram illustrating a construction of a video device according to another exemplary embodiment of the present invention.

As illustrated in FIG. 11, a control unit 1110 creates a message for requesting supportable key code information of a connected external device, and an interface 1120 transmits the request message to the external device.

FIG. 12 is a flowchart illustrating a method of providing key code information according to another exemplary embodiment of the present invention.

As illustrated in FIG. 12, a video device transmits a message for requesting supportable key code information of a connected external device (S1210). Then, the video device receives a response message regarding the supportable key code information from the external device in response to the request message (S1220).

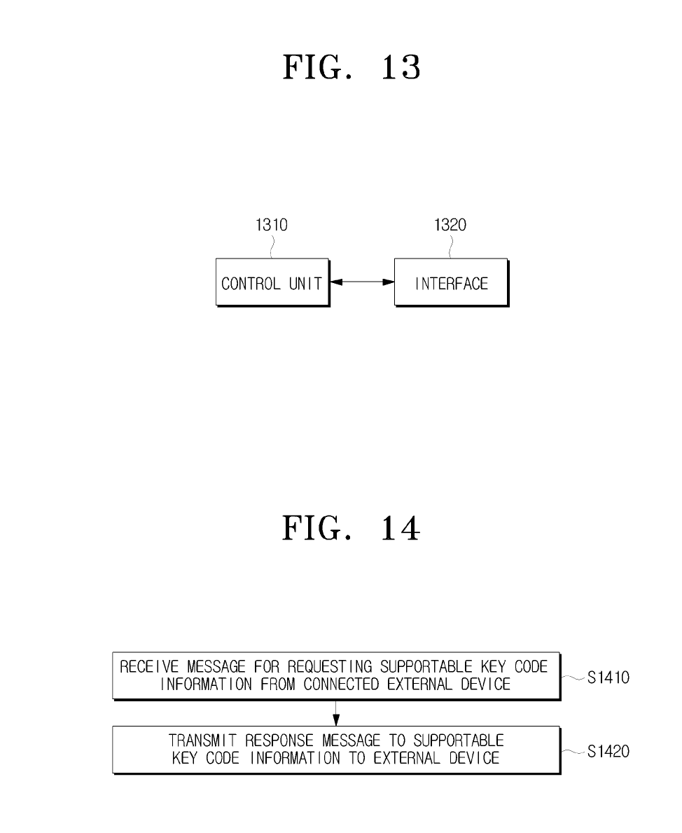

FIG. 13 is a block diagram illustrating the construction of a video device according to still another exemplary embodiment of the present invention.

As illustrated in FIG. 13, an interface 1320 receives a message for requesting supportable key code information from a connected external device. Then, a control unit 1310 creates a response message regarding the supportable key code information in response to the request message, and controls the interface 1320 to transmit the response message to the external device.

FIG. 14 is a flowchart illustrating a method of providing key code information according to still another exemplary embodiment of the present invention.

As illustrated in FIG. 14, a video device receives a message for requesting supportable key code information from a connected external device (S1410). Then, the video device transmits a response message regarding the supportable key code information to the external device in response to the request message (S1420).

Accordingly, the video device can acquire the supportable key code information provided from the connected external device.

As described above, according to the exemplary embodiments of the present invention, a method of acquiring supportable key code information of a connected external device and a video device thereof can be provided, and thus a user can control the external device through a TV remote controller more conveniently.

Particularly, the video device can exchange only the supportable key codes with the external device, and thus the compatibility between the devices can be heightened with the waste of network resources reduced.

In addition, keys supported by the external device can be provided on a display screen of the video device as an UI, and thus it is not required for a user to know functions of the external device in advance.

In addition, a message for requesting supportable key code information and a response message, which are messages not defined in the HDMI CEC standard, can be defined, and thus the supportable key code information of the external device can be acquired more efficiently and compatibly.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of providing key code information, the method comprising:
transmitting a request message that requests information on a key code which is supported by the external device; and
receiving a response message comprising the information on the key code from the external device in response to the request message.

2. The method of claim 1, wherein the information on the key code is used for controlling the external device through a video device connected to the external device.

3. The method of claim 1, wherein the external device is connected to the video device according to the High Definition Multimedia Interface Consumer Electronics Control (HDMI CEC) standard, and
wherein the information on the key code comprises information on a key code defined in the HDMI CEC standard.

4. The method of claim 1, wherein the request message comprises a command code that requests the information on the key code.

5. The method of claim 1, wherein the response message comprises:
a command code that indicates that the response message is a response to the request message; and
a supported key code table that comprises key codes supported by the external device.

6. The method of claim 5, wherein bits of the supported key code table indicate whether functions, which successively correspond to key codes defined in the High Definition Multimedia Interface Consumer Electronics Control (HDMI CEC) standard, are supported.

7. The method of claim 1, further comprising:
creating a supported key code user interface (UI) that indicates a function corresponding to the information on the key code; and
displaying the supported key code UI on a display screen.

8. The method of claim 1, further comprising:
receiving a key code input by a user through a key input unit of the video device;
transmitting the input key code to the external device if the input key code corresponds to the information on the key code; and
informing the user that the input key code corresponds to a function which is not supported by the external device if the input key code does not correspond to the information on the key code.

9. The method of claim 1, further comprising:
receiving from the external device a message indicating that the external device is in a menu active state defined in the High Definition Multimedia Interface Consumer Electronics Control (HDMI CEC) standard;
receiving a key code input by a user through a key input unit of the video device;
transmitting the input key code to the external device if the input key code corresponds to both the key code which is supported by the external device and a key code which is supported in the menu active state; and
informing the user that the input key code corresponds to a function which is not supported by the external device if the input key code corresponds to either or neither of the key code which is supported by the external device and the key code which is supported in the menu active state.

10. The method of claim 1, wherein the transmitting the message is performed when the external device is turned on, or when key codes supported by the external device are changed.

11. A video device comprising:
a control unit which creates a request message that requests information on a key code which is supported by an external device; and
an interface which transmits the request message to the external device.

12. The video device of claim 11, wherein the information on the key code is used for controlling the external device through the video device connected to the external device.

13. The video device of claim 11, wherein the external device is connected to the video device according to the High Definition Multimedia Interface Consumer Electronics Control (HDMI CEC) standard, and
wherein the information on the key code comprises information on a key code defined in the HDMI CEC standard.

14. The video device of claim 11, wherein the request message comprises a command code that requests the information on the key code.

15. The video device of claim 11, wherein the interface receives a response message comprising the information on the key code from the external device in response to the request message.

16. The video device of claim 15, wherein the response message comprises:
a command code that indicates that the response message is a response to the request message; and
a supported key code table that comprises key codes supported by the external device.

17. The video device of claim 16, wherein bits of the supported key code table indicate whether functions, which successively correspond to the key codes defined in the High Definition Multimedia Interface Consumer Electronics Control (HDMI CEC) standard, are supported.

18. The video device of claim 15, wherein the control unit is configured to display on a display unit a supported key code user interface (UI) that indicates a function corresponding to the information on the key code.

19. The video device of claim 11, further comprising a key input unit which receives a key code input from a user,
wherein the control unit controls the interface to transmit the input key code to the external device if the input key code corresponds to the information on the key code; and
wherein the control unit informs the user that the input key code corresponds to a function which is not supported by the external device if the input key code does not correspond to the information on the key code.

20. The video device of claim 11, further comprising a key input unit which receives a key code input from a user;
wherein the interface receives from the external device a message indicating that the external device is in a menu active state defined in the High Definition Multimedia Interface Consumer Electronics Control (HDMI CEC) standard,
wherein the control unit controls the interface to transmit the input key code to the external device if the input key code corresponds to both the key code which is supported by the external device and a key code which is supported in the menu active state, and
wherein the control unit informs the user that the input key code corresponds to a function which is not supported by the external device if the input key code corresponds to either or neither of the key code which is supported by the external device and the key code which is supported in the menu active state.

21. The video device of claim 11, wherein the control unit creates the request message when the external device is turned on, or when key codes supported by the external device are changed.

22. A method of providing key code information, the method comprising:
receiving a request message that requests information on a key code which is supported by a video device from an external device connected to the video device; and
transmitting a response message comprising the information on the key code to the external device in response to the request message.

23. The method of claim 22, wherein the external device is connected to the video device according to the High Definition Multimedia Interface Consumer Electronics Control (HDMI CEC) standard, and
wherein the information on the key code is used for controlling the video device through the external device.

24. A video device comprising:
an interface which receives a request message that requests information on a key code which is supported by the video device from an external device connected to the video device; and
a control unit which creates a response message comprising the information on the key code in response to the request message, and controls the interface to transmit the response message to the external device.

25. The video device of claim 24, wherein the external device is connected to the video device according to the High Definition Multimedia Interface Consumer Electronics Control (HDMI CEC) standard, and
wherein the information on the key code is used for controlling the video device through the external device.
